(19) United States
(12) Patent Application Publication
(10) Pub. No.: US 2026/0167440 A1
(43) Pub. Date: Jun. 18, 2026

(54) LINEAR CONVEYANCE SYSTEM AND METHOD FOR MANUFACTURING LINEAR CONVEYANCE SYSTEM

(71) Applicant: Mitsubishi Electric Corporation, Tokyo (JP)

(72) Inventors: Masashi OKUMA, Tokyo (JP); Yusuke KATSUDA, Tokyo (JP); Yoshinao TATEI, Tokyo (JP); Toshio MEKATA, Tokyo (JP); Hitoshi HASEGAWA, Tokyo (JP); Takashi SHIRASE, Tokyo (JP)

(73) Assignee: Mitsubishi Electric Corporation, Tokyo (JP)

(21) Appl. No.: 19/128,577

(22) PCT Filed: Apr. 13, 2023
(86) PCT No.: PCT/JP2023/015057

§ 371 Date: May 9, 2025

(51) Int. Cl. B65G 54/02; H02K 11/215; H02K 41/03

(52) U.S. Cl. CPC B65G 54/02; H02K 11/215; H02K 41/031; B65G 2203/0283

(57) ABSTRACT

A linear conveyance system includes: a base of a conveyance path module constituting a conveyance path; a mover that moves along the conveyance path; a stator provided on the base; a first position detector provided on any one of the base and the stator; and a second position detector that detects a position of the mover together with the first position detector, the second position detector being provided on the mover. The first position detector and the second position detector are disposed with a first gap therebetween in a first direction. The base is provided with a first positioning portion that restricts movement of the first position detector in a direction in which the first gap is narrowed by the movement and allows movement of the first position detector in a direction in which the first gap is widened by the movement.

### FIELD

The present disclosure relates to a linear conveyance system using a linear motor and to a method for manufacturing the linear conveyance system.

### BACKGROUND

A linear motor including a mover and a stator is used in a drive mechanism of a linear conveyance system that conveys an article such as a component. The linear conveyance system is a system that moves the mover along a track defined by a guide rail or the like. In a case where the linear conveyance system includes a guide rail, the guide rail and the stator are held on a base. In the linear conveyance system, a magnetic field is generated by energization of coils of the stator, a propulsive force for moving the mover is generated by the magnetic field, and thus the mover can be moved along the track.

The linear conveyance system generally includes a first position detector and a second position detector for detecting the position of the mover. The first position detector is provided on the stator or the base, and the second position detector is provided on the mover. The first position detector and the second position detector are disposed with a gap therebetween. In the linear conveyance system, the position of the mover is detected by the first position detector and the second position detector, and the mover is positioned accurately, and thereby components can be machined and assembled on the track.

In order to detect the position of the mover accurately, it is necessary to appropriately adjust the gap between the first position detector and the second position detector. In a case where the linear conveyance system includes a plurality of movers and a plurality of stators, it is necessary to adjust a gap between the first position detector and the second position detector for each mover and each stator. Since such gap adjustment work requires a lot of labor and time, simplification of the gap adjustment work is demanded.

Patent Literature 1 describes a technique in which a low-friction film sheet is sandwiched between a first position detector and a second position detector to adjust a gap, and then the film sheet is pulled out from the gap. Specifically, Patent Literature 1 discloses a technique in which a film sheet is inserted between the first position detector and the second position detector, the film sheet is pressed against the first position detector by the second position detector to adjust a gap, and then relative positions of the first position detector and the second position detector are fixed and the film sheet is extracted from the gap. Hereinafter, the first position detector and the second position detector may be referred to as position detectors without distinction.

### CITATION LIST

### Patent Literature

Patent Literature 1: Japanese Patent Application Laid-open No. 2013-181757

### SUMMARY OF INVENTION

### Problem to be Solved by the Invention

However, in the technique disclosed in Patent Literature 1, since the film sheet in a state of being sandwiched between the first position detector and the second position detector is pulled out, it is difficult to extract the film sheet in a case where the friction coefficients of the position detectors are high, a case where foreign matter is caught between any of the position detectors and the film sheet, or the like, which is a problem. Therefore, in the technique disclosed in Patent Literature 1, there is room for improvement in simplifying the gap adjustment work.

The present disclosure has been made in view of the above, and an object thereof is to provide a linear conveyance system capable of further simplifying gap adjustment work than before.

### Means to Solve the Problem

In order to solve the above-described problem and achieve the object, a linear conveyance system according to the present disclosure includes: a base of a conveyance path module constituting a conveyance path; a mover configured to move along the conveyance path; a stator provided on the base and constituting a linear motor together with the mover; a first position detector provided on any one of the base and the stator; and a second position detector configured to detect a position of the mover together with the first position detector, the second position detector being provided on the mover. The first position detector and the second position detector are disposed with a first gap therebetween in a first direction. The base is provided with a first positioning portion configured to restrict movement of the first position detector in a direction in which the first gap is narrowed by the movement and to allow movement of the first position detector in a direction in which the first gap is widened by the movement. The mover is provided with a first adjuster capable of adjusting a position of the second position detector in the first direction.

### Effects of the Invention

The linear conveyance system according to the present disclosure achieves an effect that it is possible to further simplify gap adjustment work than before.

### BRIEF DESCRIPTION OF DRAWINGS

FIG. 1 is a plan view illustrating the entirety of a linear conveyance system according to a first embodiment.

FIG. 2 is a side view illustrating the linear conveyance system according to the first embodiment.

FIG. 3 is a cross-sectional view illustrating the linear conveyance system according to the first embodiment.

FIG. 4 is a perspective view illustrating a mover of the linear conveyance system according to the first embodiment.

FIG. 5 is a perspective view illustrating the mover of the linear conveyance system according to the first embodiment, as viewed from an opposite side to that in FIG. 4.

FIG. 6 is a cross-sectional view for explaining a first positioning step, a temporary fixing step, a second positioning step, a first fixing step, a third positioning step, and a second fixing step of a method for manufacturing the linear conveyance system according to the first embodiment.

FIG. 7 is a cross-sectional view for explaining a moving step and a take-out step of the method for manufacturing the linear conveyance system according to the first embodiment.

FIG. 8 is a cross-sectional view illustrating the linear conveyance system according to a first modification of the first embodiment.

FIG. 9 is a cross-sectional view illustrating the linear conveyance system according to a second modification of the first embodiment.

FIG. 10 is a cross-sectional view illustrating the linear conveyance system according to a third modification of the first embodiment.

FIG. 11 is a cross-sectional view illustrating the mover, a first position detector, and a second position detector of a linear conveyance system according to a second embodiment.

FIG. 12 is a cross-sectional view illustrating the mover, the first position detector, and the second position detector of a linear conveyance system according to a third embodiment.

FIG. 13 is a cross-sectional view illustrating the mover, the first position detector, and the second position detector of a linear conveyance system according to a fourth embodiment.

FIG. 14 is a cross-sectional view illustrating a linear conveyance system according to a fifth embodiment.

FIG. 15 is a perspective view illustrating the mover of a linear conveyance system according to a sixth embodiment.

FIG. 16 is a perspective view illustrating the mover of a linear conveyance system according to a seventh embodiment.

FIG. 17 is a perspective view illustrating the mover of the linear conveyance system according to the seventh embodiment, as viewed from an opposite side to that in FIG. 16.

FIG. 18 is a cross-sectional view for explaining a method for manufacturing a linear conveyance system according to an eighth embodiment.

### DESCRIPTION OF EMBODIMENTS

Hereinafter, a linear conveyance system and a method for manufacturing the linear conveyance system according to each embodiment will be described in detail with reference to the drawings.

### First Embodiment

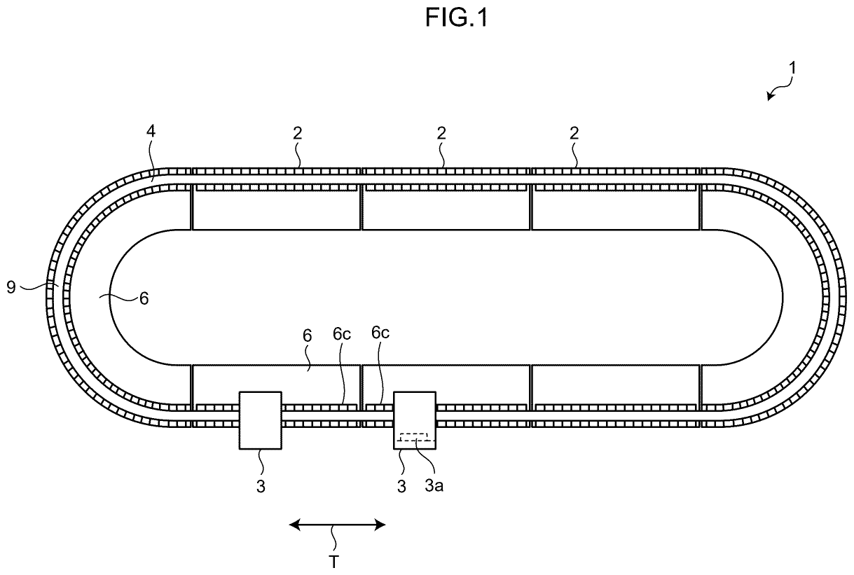

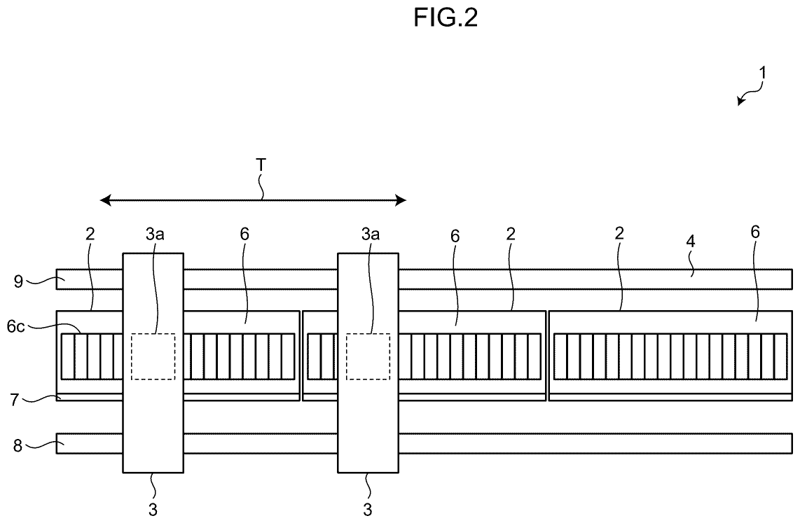

FIG. 1 is a plan view illustrating the entirety of a linear conveyance system 1 according to a first embodiment. FIG. 2 is a side view illustrating the linear conveyance system 1 according to the first embodiment. The linear conveyance system 1 is a system that conveys an article by using a linear motor. An arrow T in each of FIGS. 1 and 2 indicates a conveyance direction. The linear conveyance system 1 includes a plurality of track modules 2 and a plurality of movers 3. Although not illustrated, the linear conveyance system 1 includes a control device that controls the movement of the movers 3. The plurality of track modules 2 are connected together, thereby forming a conveyance line 4. The shape of the conveyance line 4 illustrated in FIG. 1 is a track shape in which the track modules 2 linear in shape and the track modules 2 curved in shape are connected, but may be appropriately changed. For example, the shape of the conveyance line 4 may be a linear shape in which the track modules 2 linear in shape are connected to each other, or may be a branched shape in which the conveyance line 4 is diverged into a plurality of conveyance lines 4 in the middle thereof. Each of the plurality of movers 3 moves along the conveyance line 4.

That is, the conveyance direction is a direction in which the movers 3 move along the conveyance line 4. The track module 2 is an example of a conveyance path module, and the conveyance line 4 is an example of a conveyance path.

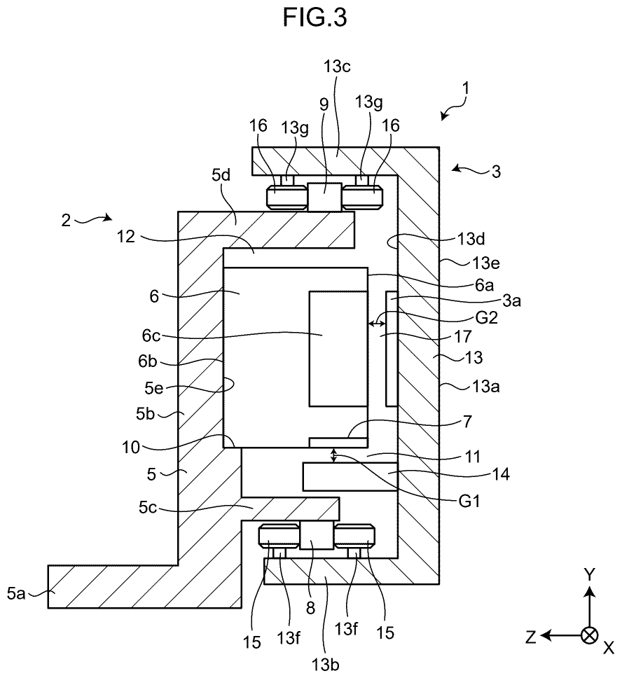

FIG. 3 is a cross-sectional view illustrating the linear conveyance system 1 according to the first embodiment. FIG. 3 illustrates a cross-section perpendicular to the conveyance direction of the movers 3. In the following description, a direction perpendicular to the paper plane of FIG. 3 is defined as an X-axis direction, and two directions perpendicular to each other in the paper plane of FIG. 3 are defined as a Y-axis direction and a Z-axis direction. In the following description, a positive X-axis direction is the conveyance direction of the movers 3, and the Y-axis direction is a vertical direction. In the following description, a positive Y-axis direction is defined as upward, and a negative Y-axis direction is defined as downward. In the cross-sectional views of FIG. 3 and subsequent figures, cross-hatching is given only to the mover 3 and a base 5 to be described later.

Each track module 2 includes the base 5, a stator 6, a first position detector 7, and two guide rails 8 and 9.

The base 5 is a member that holds the stator 6, the first position detector 7, and the guide rails 8 and 9. The base 5 includes a bottom portion 5a, a holding portion 5b, and two guide rail attachment portions 5c and 5d. The bottom portion 5a extends in the Z-axis direction. The holding portion 5b extends upward in the Y-axis direction from, among end portions of the bottom portion 5a in the Z-axis direction, an end portion facing the mover 3. The stator 6 is attached to the holding portion 5b. The first position detector 7 is attached to the holding portion 5b via the stator 6. The holding portion 5b includes a base-side side surface be facing the mover 3. The base-side side surface 5e is provided with a first positioning portion 10. Details of the first positioning portion 10 will be described later.

The guide rail attachment portion 5c as one of the guide rail attachment portions extends in the Z-axis direction toward the mover 3 from a portion of the base-side side surface 5e of the holding portion 5b, the portion being in the vicinity of a boundary with the bottom portion 5a. The guide rail attachment portion 5d as the other of the guide rail attachment portions extends in the Z-axis direction toward the mover 3 from an upper end portion of the holding portion 5b. The guide rail attachment portion 5c and the guide rail attachment portion 5d are disposed with a space therebetween in the Y-axis direction. The guide rail attachment portion 5c and the guide rail attachment portion 5d are disposed in parallel to each other.

The stator 6 is a member that is provided on the base 5 and constitutes a linear motor together with the mover 3 The stator 6 is disposed between the two guide rail attachment portions 5c and 5d with a space from each of the two guide rail attachment portions 5c and 5d. The stator 6 includes a first stator-side side surface 6a facing the mover 3 and a second stator-side side surface 6b facing opposite the mover 3. The stator 6 includes a plurality of coils 6c disposed side by side in the X-axis direction. Each coil 6c is disposed on the first stator-side side surface 6a. The second stator-side side surface 6b is in contact with the base-side side surface 5e.

A part of a surface of the stator 6 facing a second position detector 14 to be described later is in contact with the first positioning portion 10.

Hereinafter, in the present embodiment, the surface of the stator 6 facing the second position detector 14 to be described later may be referred to as a lower surface. A portion of the lower surface of the stator 6, the portion being in the vicinity of a boundary with the second stator-side side surface 6b, is in contact with the first positioning portion 10.

The stator 6 includes a motor driver (not illustrated). The motor driver includes a substrate that controls a current flowing through each of the plurality of coils 6c. That is, the motor driver has a function of controlling the current of each coil 6c. The motor driver also has a function of performing communication with the first position detector 7, communication between adjacent motor drivers, communication with a host control device, and the like. The motor driver may be integrated with the stator 6, the first position detector 7, and the guide rail 8 to form the track module 2, but may be independently provided separately from the track module 2.

The first position detector 7 is a member provided on the stator 6. The first position detector 7 is, for example, a substrate including a plurality of Hall elements. The first position detector 7 is provided on the lower surface of the stator 6. The first position detector 7 is disposed away from a portion of the lower surface of the stator 6 in the Z-axis direction, the portion being in contact with the first positioning portion 10.

The guide rail 8 as one of the guide rails is provided on the guide rail attachment portion 5c as one of the guide rail attachment portions. The guide rail 9 as the other of the guide rails is provided on the guide rail attachment portion 5d as the other of the guide rail attachment portions. The guide rail 8 is provided on a lower surface of the guide rail attachment portion 5c. The guide rail 9 is provided on an upper surface of the guide rail attachment portion 5d.

Each mover 3 includes a mover main body 13, the second position detector 14, and pluralities of guide rollers 15 and 16. The mover 3 moves along the conveyance path by moving along the guide rails 8 and 9.

The mover main body 13 includes a magnet attachment portion 13a and two guide roller attachment portions 13b and 13c. The magnet attachment portion 13a and the two guide roller attachment portions 13b and 13c are formed integrally in the present embodiment. The magnet attachment portion 13a extends in the Y-axis direction. The magnet attachment portion 13a is disposed with a space from the stator 6 and the base 5 in the Z-axis direction. The magnet attachment portion 13a includes a first mover-side side surface 13d facing the stator 6 and a second mover-side side surface 13e facing opposite the stator 6.

The mover main body 13 includes a motor magnet 3a. The motor magnet 3a is provided on the first mover-side side surface 13d. The motor magnet 3a is, for example, a plurality of permanent magnets. The motor magnet 3a is constituted with S-pole permanent magnets and N-pole permanent magnets alternately disposed in the X-axis direction. The positions of the motor magnet 3a and the coils 6c in the Y-axis direction coincide with each other. That is, the motor magnet 3a and the coils 6c are disposed at positions facing each other. The motor magnet 3a is disposed with a second gap 17 from the coils 6c in the Z-axis direction. Hereinafter, a width direction of the second gap 17 is referred to as a coil gap direction G2.

In other words, the second gap 17 is a distance between the motor magnet 3a and the coils 6c facing each other. The coil gap direction G2 is a direction along the distance between the motor magnet 3a and the coils 6c facing each other. In the present embodiment, the coil gap direction G2 is a second direction and is a direction parallel to the Z-axis direction. A magnetic field is generated by the current flowing through each coil 6c, and a propulsive force is generated in the motor magnet 3a by the magnetic field, and thereby the mover 3 can be moved.

The second position detector 14 is a member that is provided on the mover 3 and detects the position of the mover 3 together with the first position detector 7. The second position detector 14 is, for example, a scale magnet including a plurality of magnetic poles. Positions of the first position detector 7 and the second position detector 14 in the Z-axis direction coincide with each other. That is, the first position detector 7 and the second position detector 14 are disposed at positions facing each other.

The first position detector 7 and the second position detector 14 are disposed with a first gap 11 therebetween in the Y-axis direction. Hereinafter, a width direction of the first gap 11 is referred to as a detector gap direction G1. In other words, the first gap 11 is a distance between the first position detector 7 and the second position detector 14 facing each other. The detector gap direction G1 is a direction along the distance between the first position detector 7 and the second position detector 14 facing each other. In the present embodiment, the detector gap direction G1 is a first direction and is a direction parallel to the Y-axis direction. In the present embodiment, the detector gap direction G1 is a direction perpendicular to the coil gap direction G2. The second position detector 14 is provided on the first mover-side side surface 13d. The second position detector 14 is disposed below the motor magnet 3a away from the motor magnet 3a. The configurations of the first position detector 7 and the second position detector 14 are not limited to those in the illustrated example as long as the position of the mover 3 can be detected. A method for detecting the position of the mover 3 may be, for example, a method using an optical system.

The guide roller attachment portion 13b as one of the guide roller attachment portions extends in the Z-axis direction toward the base 5 from a lower end portion of the magnet attachment portion 13a. The guide roller attachment portion 13b as one of the guide roller attachment portions is disposed below the guide rail attachment portion 5c away from the guide rail attachment portion 5c. The guide roller attachment portion 13c as the other of the guide roller attachment portions extends in the Z-axis direction toward the base 5 from an upper end portion of the magnet attachment portion 13a. The guide roller attachment portion 13c as the other of the guide roller attachment portions is disposed above the guide rail attachment portion 5d away from the guide rail attachment portion 5d. The guide roller attachment portion 13b and the guide roller attachment portion 13c are disposed with a space therebetween in the Y-axis direction. The guide roller attachment portion 13b and the guide roller attachment portion 13c are disposed in parallel to each other.

The guide rollers 15 and 16 and the guide rails 8 and 9 are members for holding the mover 3 so that the mover 3 does not move in a direction other than the conveyance direction. A plurality of guide roller shafts 13f extending in the Y-axis direction are provided on an upper surface of the guide roller attachment portion 13b. The guide rollers 15 are provided on the guide roller shafts 13f one by one, and rotate around the guide roller shafts 13f. Two guide rollers 15 constitute one pair. The pair of the guide rollers 15 are disposed apart from each other in the Z-axis direction with the guide rail 8 interposed therebetween.

A plurality of guide roller shafts 13g extending in the Y-axis direction are provided on a lower surface of the guide roller attachment portion 13c. The guide rollers 16 are provided on the guide roller shafts 13g one by one, and rotate around the guide roller shafts 13g. Two guide rollers 16 constitute one pair. The pair of the guide rollers 16 are disposed apart from each other in the Z-axis direction with the guide rail 9 interposed therebetween.

The guide rollers 15 and 16 are flat rollers in the present embodiment, but are not particularly limited as long as the guide rollers 15 and 16 can hold the mover 3 so that the mover 3 does not move in a direction other than the conveyance direction. The guide rails 8 and 9 are flat guide rails in the present embodiment, but are not particularly limited as long as the guide rails 8 and 9 can hold the mover 3 so that the mover 3 does not move in a direction other than the conveyance direction. For example, the guide rollers 15 and 16 may be V rollers in a V shape, and grooves in the guide rails 8 and 9 at portions where the guide rollers 15 and 16 are to be fitted into may have a V shape. The linear conveyance system 1 may be configured to hold the mover 3 by means different from the guide rollers 15 and 16 and the guide rails 8 and 9.

Next, the first positioning portion 10 will be described in detail with reference to FIG. 3.

The base 5 is provided with the first positioning portion 10 for defining the positions of the stator 6 and the first position detector 7 in the detector gap direction G1 at a time of manufacturing the linear conveyance system 1. The first positioning portion 10 is a portion that restricts the movement of the first position detector 7 in a direction in which the first gap 11 is narrowed by the movement and allows the movement of the first position detector 7 in a direction in which the first gap 11 is widened by the movement, at the time of manufacturing the linear conveyance system 1. In the present embodiment, the first positioning portion 10 is a step extending in the Z-axis direction. In a state where the stator 6 is in contact with the first positioning portion 10, on an opposite side of the stator 6 from the second position detector 14, a space 12 for allowing movement of the stator 6 in a direction in which the first gap 11 is widened by the movement is provided. The space 12 is formed between an upper surface of the stator 6 and a lower surface of the guide rail attachment portion 5d.

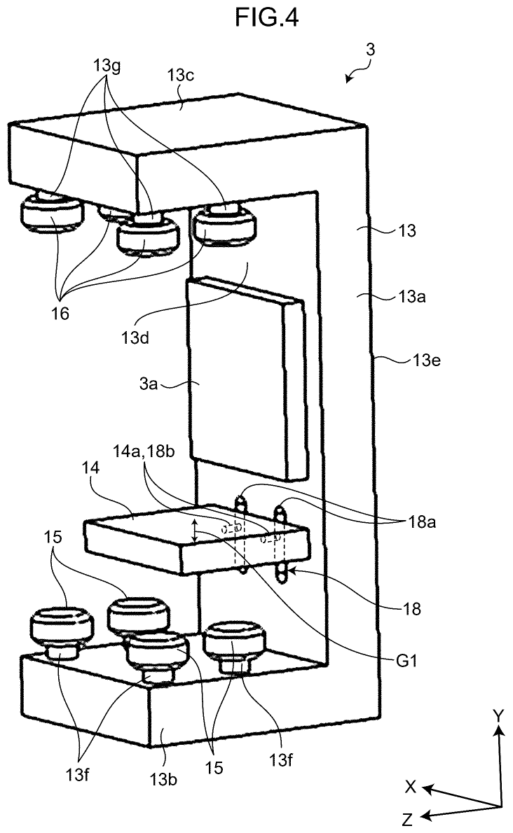

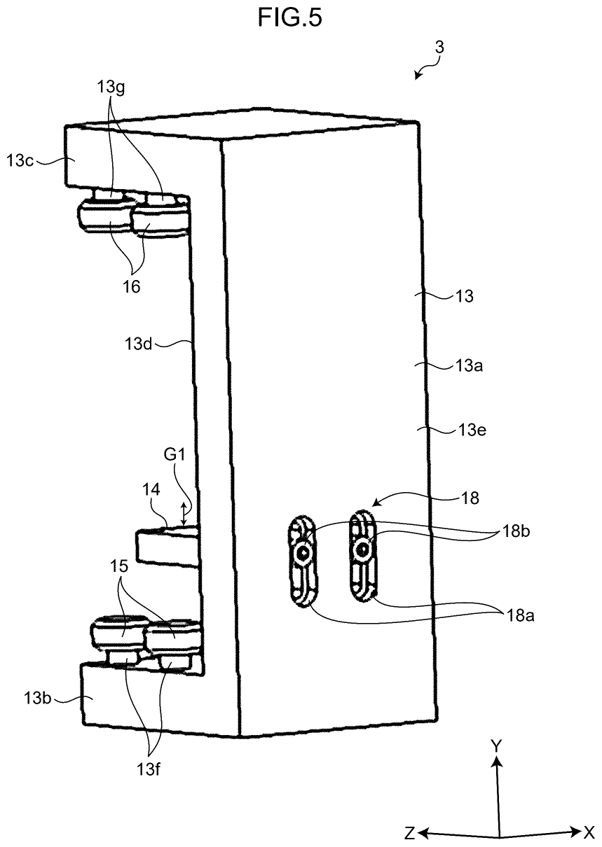

Next, a first adjuster 18 will be described with reference to FIGS. 4 and 5. FIG. 4 is a perspective view illustrating the mover 3 of the linear conveyance system 1 according to the first embodiment. FIG. 5 is a perspective view illustrating the mover 3 of the linear conveyance system 1 according to the first embodiment, as viewed from an opposite side to that in FIG. 4.

The mover 3 is provided with the first adjuster 18 capable of adjusting the position of the second position detector 14 in the detector gap direction G1. The first adjuster 18 moves the second position detector 14 in a direction in which the first gap 11 is narrowed by the movement and moves the second position detector 14 in a direction in which the first gap 11 is widened by the movement. The first adjuster 18 is provided on the magnet attachment portion 13a. In the mover 3 of the present embodiment, the first adjuster 18 is constituted with elongated holes 18a that have a length in the Y-axis direction longer than a length in the X-axis direction, and with fixing screws 18b. Each elongated hole 18a pierces the magnet attachment portion 13a in the Z-axis direction. The elongated hole 18a is a through hole longer in the Y-axis direction than in the X-axis direction. The second position detector 14 is formed with screw holes 14a each communicating with the elongated hole 18a. Each fixing screw 18b is inserted in the elongated hole 18a and the screw hole 14a. By screwing each fixing screw 18b inserted in the elongated hole 18a into the screw hole 14a, the second position detector 14 is fixed to the mover 3. A length dimension of the elongated hole 18a in the Y-axis direction is larger than the diameter of the fixing screw 18b. With this configuration, the fixing screw 18b inserted in the elongated hole 18a can be moved in the Y-axis direction. In a case of adjusting the position of the second position detector 14 in the Y-axis direction, it is only required to change the positions of the fixing screws 18b inserted in the elongated holes 18a in the Y-axis direction, and to screw the fixing screws 18b into the screw holes 14a.

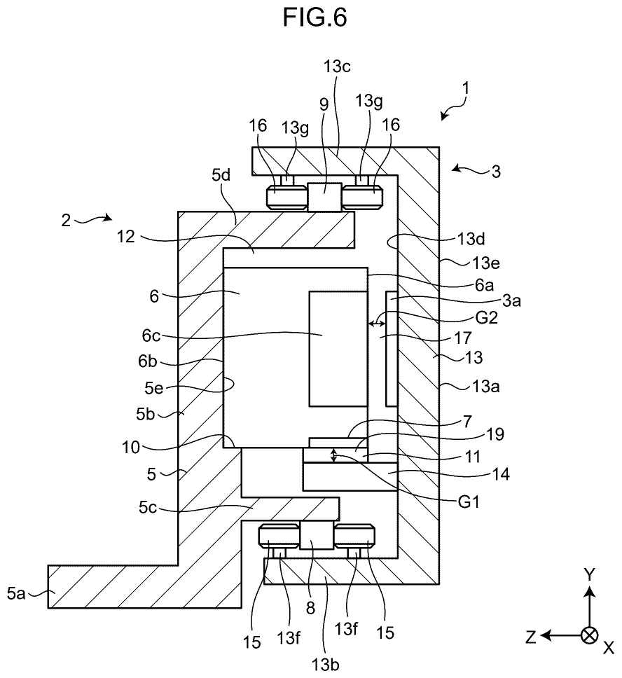

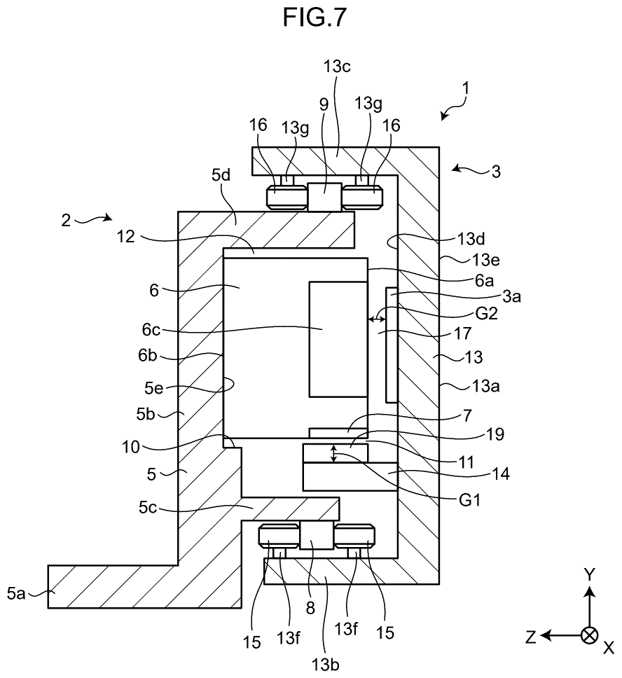

Next, a method for manufacturing the linear conveyance system 1 according to the present embodiment will be described with reference to FIGS. 6 and 7. FIG. 6 is a cross-sectional view for explaining a first positioning step, a temporary fixing step, a second positioning step, a first fixing step, a third positioning step, and a second fixing step of the method for manufacturing the linear conveyance system 1 according to the first embodiment. FIG. 7 is a cross-sectional view for explaining a moving step and a take-out step of the method for manufacturing the linear conveyance system 1 according to the first embodiment. As illustrated in FIGS. 6 and 7, the method for manufacturing the linear conveyance system 1 includes the first positioning step, the temporary fixing step, the second positioning step, the first fixing step, the moving step, the take-out step, the third positioning step, and the second fixing step.

As illustrated in FIG. 6, the first positioning step is a step of positioning the first position detector 7 in the detector gap direction G1 by bringing the stator 6 into contact with the first positioning portion 10 to restrict the movement of the first position detector 7 in the direction in which the first gap 11 is narrowed by the movement. In the first positioning step, a part of the lower surface of the stator 6 is brought into contact with the step which is the first positioning portion 10. In the first positioning step, the positions of the stator 6 and the first position detector 7 in the detector gap direction G1 are determined.

The temporary fixing step is a step of fixing the stator 6 to the base 5. In the temporary fixing step, the stator 6 is fixed to the base 5 by a fixing screw (not illustrated) at the positions of the stator 6 and the first position detector 7 determined in the first positioning step. When the stator 6 is fixed to the base 5, the first position detector 7 attached to the stator 6 is also fixed to the base 5. The temporary fixing step may be skipped, but by fixing the stator 6 and the first position detector 7 to the base 5 in the temporary fixing step, it is possible to eliminate, in respective steps of manufacturing the linear conveyance system 1 including the second positioning step to be described later, the possibility of displacement of the stator 6 and the first position detector 7 from the positions determined in the first positioning step, and the respective steps can be smoothly advanced.

The second positioning step is a step of positioning the second position detector 14 in the detector gap direction G1 by sandwiching a gap adjustment component 19 between the first position detector 7 and the second position detector 14. In the second positioning step, the second position detector 14 is moved toward the first position detector 7 to press the gap adjustment component 19 against the first position detector 7 by the second position detector 14, and thereby the position of the second position detector 14 in the detector gap direction G1 is determined. The configuration of the gap adjustment component 19 is not particularly limited as long as the position of the second position detector 14 in the detector gap direction G1 can be determined by pressing the gap adjustment component 19 against the first position detector 7. The shape of the gap adjustment component 19 may be, for example, a sheet shape or a plate shape. The material of the gap adjustment component 19 may be, for example, resin or metal. The thickness of the gap adjustment component 19 in the detector gap direction G1 is the same as a desired width of the first gap 11.

The first fixing step is a step of fixing the second position detector 14 to the mover 3 in a state where the gap adjustment component 19 is sandwiched between the first position detector 7 and the second position detector 14. In the first fixing step, the second position detector 14 is fixed to the mover 3 by screwing each fixing screw 18b inserted in the elongated hole 18a illustrated in FIGS. 4 and 5 into the screw hole 14a.

As illustrated in FIG. 7, the moving step is a step of moving the first position detector 7 in the direction in which the first gap 11 is widened by the movement. In the moving step, a fixing screw (not illustrated) is loosened to make the stator 6 movable with respect to the base 5, and then the stator 6 provided with the first position detector 7 is moved in the direction in which the first gap 11 is widened by the movement. Consequently, the width of the first gap 11 becomes larger than the thickness of the gap adjustment component 19, and thus the gap adjustment component 19 can be easily taken out from the first gap 11.

The take-out step is a step of taking out the gap adjustment component 19 from the first gap 11. In the take-out step, the gap adjustment component 19 is moved in the X-axis direction which is a direction perpendicular to the detector gap direction G1, and is taken out from the first gap 11.

As illustrated in FIG. 6, the third positioning step is a step of positioning the first position detector 7 in the detector gap direction G1 by bringing the stator 6 into contact with the first positioning portion 10 to restrict the movement of the first position detector 7 in the direction in which the first gap 11 is narrowed by the movement. In the third positioning step, a part of the lower surface of the stator 6 is brought into contact with the step which is the first positioning portion 10. In the third positioning step, the positions of the stator 6 and 19 the first position detector 7 in the detector gap direction G1 are determined.

The second fixing step is a step of fixing the stator 6 to the base 5. In the second fixing step, the stator 6 is fixed to the base 5 by a fixing screw (not illustrated). By performing the above steps, the linear conveyance system 1 illustrated in FIG. 3 can be assembled and manufactured.

Next, an effect of the linear conveyance system 1 according to the present embodiment will be described.

In the present embodiment, as illustrated in FIG. 3, the base 5 is provided with the first positioning portion 10 that restricts the movement of the first position detector 7 in the direction in which the first gap 11 is narrowed by the movement and allows the movement of the first position detector 7 in the direction in which the first gap 11 is widened by the movement. In addition, in the present embodiment, as illustrated in FIGS. 4 and 5, the mover 3 is provided with the first adjuster 18 capable of adjusting the position of the second position detector 14 in the detector gap direction G1. With these configurations, after the gap adjustment component 19 is pressed against the first position detector 7 by the second position detector 14 to fix the second position detector 14 to the mover 3 as illustrated in FIG. 6, the first position detector 7 can be moved in the direction in which the first gap 11 is widened by the movement as illustrated in FIG. 7. Then, since the gap adjustment component 19 can be taken out in a state where the width of the first gap 11 is larger than the thickness of the gap adjustment component 19, the gap adjustment component 19 can be easily taken out as compared with a case where the gap adjustment component 19 in a state of being sandwiched between the first position detector 7 and the second position detector 14 is extracted. That is, in the present embodiment, the gap adjustment component 19 does not rub against the first position detector 7 and the second position detector 14 when the gap adjustment component 19 is taken out, and thus the gap adjustment component 19 can be easily taken out even in a case where friction coefficients of the position detectors are high. In addition, in the present embodiment, even if foreign matter is caught between the gap adjustment component 19 and the first position detector 7 and the second position detector 14 when the gap adjustment component 19 is taken out, there is no need to pull out the gap adjustment component 19 in a state of being sandwiched between the first position detector 7 and the second position detector 14. Therefore, damage to the first position detector 7 and the second position detector 14 due to the foreign matter can be prevented, and the gap adjustment component 19 can be easily taken out. Therefore, in the present embodiment, it is possible to further simplify work of adjusting the first gap 11 than before.

In the present embodiment, as illustrated in FIG. 6, the position of the first position detector 7 is uniquely determined by the first positioning portion 10, so that even if the first position detector 7 is once moved and then fixed to the base 5 again, the displacement of the position of the first position detector 7 between before the movement and after the re-fixing is suppressed. Consequently, it is possible to suppress the displacement of the relative positions of the first position detector 7 and the second position detector 14 between before the movement and after the re-fixing, which eliminates the necessity of readjustment of the first gap 11.

As described above, in the present embodiment, as illustrated in FIG. 7, the gap adjustment component 19 can be taken out in a state where the width of the first gap 11 is larger than the thickness of the gap adjustment component 19. Therefore, damage to the gap adjustment component 19, the first position detector 7, and the second position detector 14 can be prevented when the gap adjustment component 19 is taken out.

In the present embodiment, as illustrated in FIG. 6, the first position detector 7 and the second position detector 14 are positioned with reference to the first positioning portion 10. Consequently, in a case of where replacement of a failed stator 6, a change in the path of the conveyance line 4, or the like is made after the plurality of track modules 2 and the plurality of movers 3 are assembled, the necessity of the work of adjusting the first gap 11 is eliminated, and it is only required to bring a new stator 6 into contact with the first positioning portion 10 to fix the new stator 6 to the base 5. Therefore, a time to be spent on manufacturing the linear conveyance system 1 can be shortened.

According to the method for manufacturing the linear conveyance system 1 according to the present embodiment described above, as illustrated in FIGS. 6 and 7, the first position detector 7 and the second position detector 14 can be assembled to the linear conveyance system 1 without being affected by tolerances of the guide rails 8 and 9, the guide rollers 15 and 16, the base 5, and the mover 3. Consequently, the manufacturing cost of the linear conveyance system 1 can be reduced.

In the present embodiment, as illustrated in FIGS. 4 and 5, the mover 3 is provided with the first adjuster 18 capable of adjusting the position of the second position detector 14 in the detector gap direction G1 which is the first direction. With this configuration, as illustrated in FIG. 6, the second position detector 14 can be fixed to the mover 3 at a position where the gap adjustment component 19 is pressed against the first position detector 7 by the second position detector 14.

In the present embodiment, as illustrated in FIG. 3, the stator 6 includes the coils 6c, and the mover 3 includes the motor magnet 3a disposed with the second gap 17 from the coils 6c in the coil gap direction G2. The detector gap direction G1 is a direction perpendicular to the coil gap direction G2. With this configuration, the first gap 11 can be adjusted without affecting the second gap 17. That is, the first gap 11 can be independently adjusted separately from the second gap 17. Consequently, it is possible to suppress the adjustment of the first gap 11 from affecting a thrust of the mover 3.

Next, modifications of the first embodiment will be described.

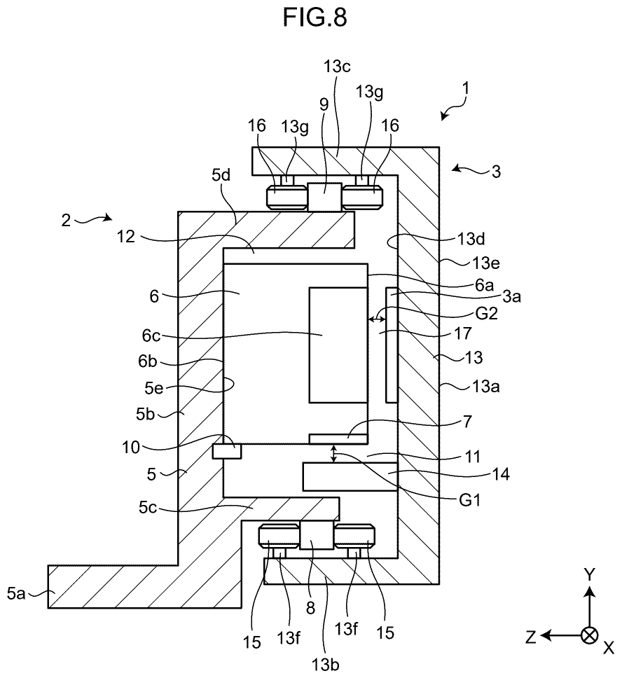

The first positioning portion 10 illustrated in FIG. 3 is not particularly limited as long as the structure thereof is capable of restricting the movement of the first position detector 7 in the direction in which the first gap 11 is narrowed by the movement and allowing the movement of the first position detector 7 in the direction in which the first gap 11 is widened by the movement. The first positioning portion 10 may have, for example, a structure illustrated in FIG. 8. FIG. 8 is a cross-sectional view illustrating the linear conveyance system 1 according to a first modification of the first embodiment. The first positioning portion 10 illustrated in FIG. 8 is a pin attached to the base 5 and protruding from the base 5 toward the stator 6. The first positioning portion 10 is formed separately from the base 5. The first positioning portion 10 protrudes toward the stator 6 beyond the base-side side surface 5e. In a case where the first positioning portion 10 is the pin, it is preferable that at least two pins be disposed side by side in the X-axis direction. Note that the first positioning portion 10 may be a protrusion formed integrally with the base 5 and protruding from the base 5 toward the stator 6. The shape of the protrusion is not particularly limited. The shape of the protrusion may be, for example, a columnar shape, or a quadrangular prism shape longer in the X-axis direction than in the Y-axis direction.

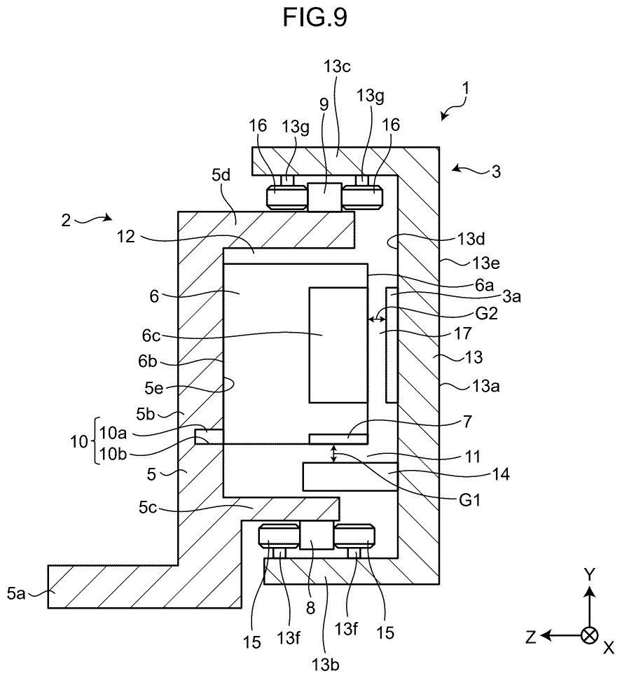

The first positioning portion 10 may have, for example, a structure illustrated in FIG. 9. FIG. 9 is a cross-sectional view illustrating the linear conveyance system 1 according to a second modification of the first embodiment. The first positioning portion 10 illustrated in FIG. 9 is constituted with a protrusion 10a protruding from the stator 6 toward the base 5, and a hole 10b provided in the base 5 and into which the protrusion 10a of the stator 6 is fitted. The shape of the protrusion 10a is not particularly limited. The shape of the protrusion 10a may be, for example, a columnar shape, or a quadrangular prism shape longer in the X-axis direction than in the Y-axis direction. Note that a pin may be used instead of the protrusion 10a. The shape of the hole 10b is appropriately changed depending on the shape of the protrusion 10a or the pin.

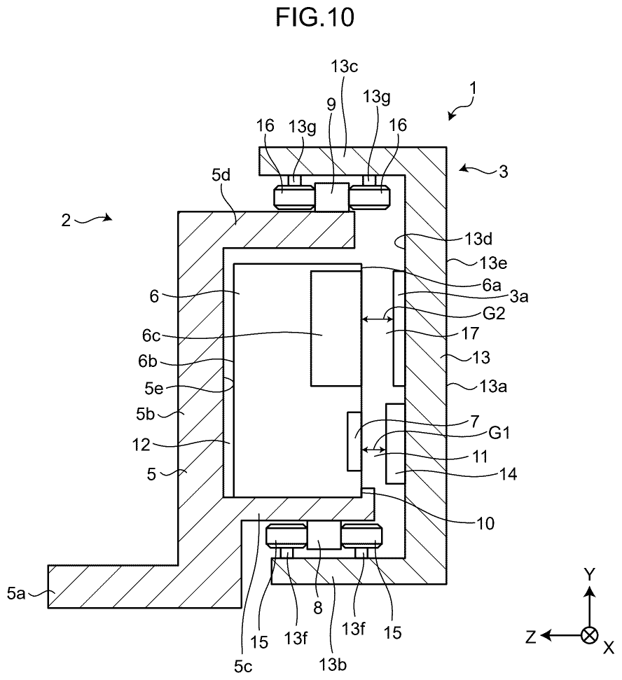

In the first embodiment described above, the detector gap direction G1 is a direction perpendicular to the coil gap direction G2, but the detector gap direction G1 may be a direction parallel to the coil gap direction G2 as illustrated in FIG. 10. FIG. 10 is a cross-sectional view illustrating the linear conveyance system 1 according to a third modification of the first embodiment. The stator 6 is attached to the guide rail attachment portion 5c as one of the guide rail attachment portions. In addition, the first position detector 7 is attached to the guide rail attachment portion 5c via the stator 6. A surface of the guide rail attachment portion 5c facing the stator 6 is provided with the first positioning portion 10 for defining the positions of the stator 6 and the first position detector 7 in the detector gap direction G1 at the time of manufacturing the linear conveyance system 1. A surface of the guide rail attachment portion 5c facing upward and facing the stator 6 is an upper surface in the present modification. The first positioning portion 10 is a portion that restricts the movement of the first position detector 7 in a direction in which the first gap 11 is narrowed by the movement and allows the movement of the first position detector 7 in a direction in which the first gap 11 is widened by the movement, at the time of manufacturing the linear conveyance system 1. In the present modification, the first positioning portion 10 is a step extending in the Y-axis direction from the upper surface of the guide rail attachment portion 5c. The first positioning portion 10 is provided on the upper surface of the guide rail attachment portion 5c as one of the guide rail attachment portions.

A surface of the stator 6 facing the guide rail attachment portion 5c is in contact with the upper surface of the guide rail attachment portion 5c. The surface of the stator 6 facing the guide rail attachment portion 5c is a lower surface in the present modification. A part of the stator 6 is in contact with the first positioning portion 10. Specifically, a portion of the first stator-side side surface 6a of the stator 6, the portion being in the vicinity of a boundary with the lower surface, is in contact with the first positioning portion 10. In a state where the stator 6 is in contact with the first positioning portion 10, on an opposite side of the stator 6 from the second position detector 14, a space 12 for allowing movement of the stator 6 in a direction in which the first gap 11 is widened by the movement is provided. The space 12 is formed between the second stator-side side surface 6b of the stator 6 and the base-side side surface 5e.

The first position detector 7 is provided on the first stator-side side surface 6a of the stator 6. The first position detector 7 is disposed away from a portion of the first stator-side side surface 6a in the Y-axis direction, the portion being in contact with the first positioning portion 10. The first position detector 7 is disposed above the first positioning portion 10 and away from the first positioning portion 10. The first position detector 7 is disposed below the coils 6c and away from the coils 6c.

Positions of the first position detector 7 and the second position detector 14 in the Y-axis direction coincide with each other. That is, the first position detector 7 and the second position detector 14 are disposed at positions facing each other. The first position detector 7 and the second position detector 14 are disposed with the first gap 11 therebetween in the Z-axis direction. The detector gap direction G1 is a direction parallel to the Z-axis direction. The coil gap direction G2 is a direction parallel to the Z-axis direction. That is, in the present modification, the detector gap direction G1 is a direction parallel to the coil gap direction G2.

Even in such a modification, similarly to the first embodiment described above, it is possible to further simplify the work of adjusting the first gap 11 than before. In addition, a time to be spent on manufacturing the linear conveyance system 1 can be shortened, and the manufacturing cost of the linear conveyance system 1 can be reduced.

### Second Embodiment

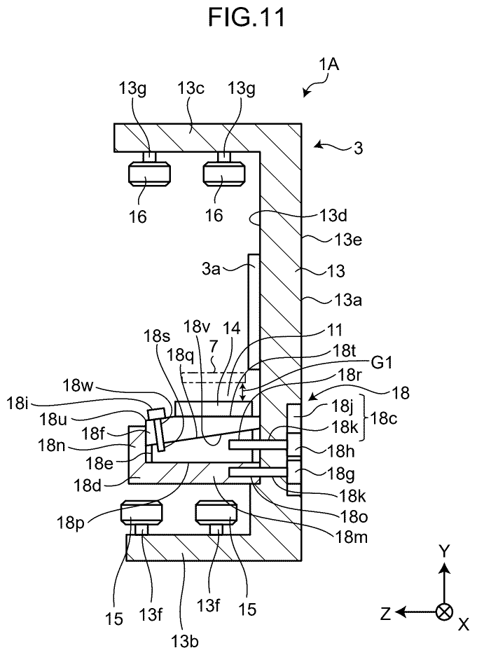

Next, a linear conveyance system 1A according to a second embodiment will be described with reference to FIG. 11. FIG. 11 is a cross-sectional view illustrating the mover 3, the first position detector 7, and the second position detector 14 of the linear conveyance system 1A according to the second embodiment. In the present embodiment, the configuration of the first adjuster 18 is different from that in the first embodiment described above. In the second embodiment, the same reference numerals are given to parts same as those in the first embodiment described above, and descriptions thereof will be omitted. In FIG. 11, the first position detector 7 is illustrated by a dash-dotted line, and cross-hatching of some members is omitted.

The first adjuster 18 is constituted with a through hole 18c, a housing member 18d, a first wedge component 18e, a second wedge component 18f, a first fixing screw 18g, an adjustment screw 18h, and a second fixing screw 18i. The first adjuster 18 moves the second position detector 14 in a direction in which the first gap 11 is narrowed by the movement and moves the second position detector 14 in a direction in which the first gap 11 is widened by the movement.

The through hole 18c is formed in the magnet attachment portion 13a. The through hole 18c includes an elongated hole 18j that is open to the second mover-side side surface 13e and has a length in the Y-axis direction longer than a length in the X-axis direction, and a plurality of insertion holes 18k that pierce from a bottom surface of the elongated hole 18j to the first mover-side side surface 13d. In the elongated hole 18j, a head of the adjustment screw 18h and a head of the first fixing screw 18g are disposed. The plurality of insertion holes 18k are disposed with a space therebetween in the Y-axis direction. The number of insertion holes 18k is two in the present embodiment. The adjustment screw 18h is inserted in one insertion hole 18k, and the first fixing screw 18g is inserted in the other insertion hole 18k.

The housing member 18d is a member that houses the first wedge component 18e and the second wedge component 18f. The housing member 18d is open toward the first position detector 7. The housing member 18d includes a bottom wall portion 18m and a side wall portion 18n. The bottom wall portion 18m extends in the Z-axis direction from the magnet attachment portion 13a toward the base 5 (not illustrated). The side wall portion 18n extends in the Y-axis direction from a distal end of the bottom wall portion 18m toward the first position detector 7. A screw hole 180 communicable with one insertion hole 18k is formed in the bottom wall portion 18m. The first fixing screw 18g is inserted in the screw hole 180. By screwing the first fixing screw 18g into the insertion hole 18k of the magnet attachment portion 13a and the screw hole 180 of the housing member 18d, the housing member 18d is fixed to the magnet attachment portion 13a. On the bottom wall portion 18m of the housing member 18d, the first wedge component 18e, the second wedge component 18f, and the second position detector 14 are stacked. The first wedge component 18e, the second wedge component 18f, and the second position detector 14 are disposed in this order, which is ascending order of distance from the bottom wall portion 18m of the housing member 18d. The first wedge component 18e and the second wedge component 18f are disposed between the magnet attachment portion 13a and the side wall portion 18n.

The first wedge component 18e is disposed with an interval from each of the magnet attachment portion 13a and the side wall portion 18n in the Z-axis direction. The first wedge component 18e includes a bottom surface 18p and a first inclined surface 18q. The bottom surface 18p extends in the Z-axis direction along the bottom wall portion 18m. The first inclined surface 18q is oblique to the Y-axis direction. The first inclined surface 18q is inclined in a direction away from the first position detector 7 toward the base 5 from the mover 3. A screw hole 18r communicable with one insertion hole 18k is formed in the first wedge component 18e. The adjustment screw 18h is inserted in the screw hole 18r. By loosening the adjustment screw 18h, the first wedge component 18e moves in a positive Z-axis direction. By tightening the adjustment screw 18h, the first wedge component 18e moves in a negative Z-axis direction. A screw hole 18s open to the first inclined surface 18q is formed in the first wedge component 18e. The second fixing screw 18i is inserted in the screw hole 18s.

The second wedge component 18f includes a placement surface 18t, an attachment surface 18u, and a second inclined surface 18v. The placement surface 18t extends linearly in the Z-axis direction from the mover 3 toward the base 5. The second position detector 14 is installed on the placement surface 18t. The attachment surface 18u is continuous with an end portion of the placement surface 18t, the end portion facing the base 5. The second inclined surface 18v is oblique to the Y-axis direction. The second inclined surface 18v is inclined in a direction away from the first position detector 7 toward the base 5 from the mover 3. The second inclined surface 18v is in surface contact with the first inclined surface 18q. The second inclined surface 18v is parallel to the first inclined surface 18q and the attachment surface 18u. A screw hole 18w open to the second inclined surface 18v is formed in the second wedge component 18f. The second fixing screw 18i is inserted in the screw hole 18w. Along with the movement of the first wedge component 18e in the Z-axis direction, the second wedge component 18f moves in the Y-axis direction. Specifically, along with the movement of the first wedge component 18e in the positive Z-axis direction, the second wedge component 18f moves in the positive Y-axis direction. Along with the movement of the first wedge component 18e in the negative Z-axis direction, the second wedge component 18f moves in the negative Y-axis direction.

The first fixing screw 18g is a member for fixing the housing member 18d to the magnet attachment portion 13a. The axial direction of the first fixing screw 18g coincides with the Z-axis direction. The adjustment screw 18h is a member for moving the first wedge component 18e in the Z-axis direction to adjust the position of the second position detector 14 installed on the second wedge component 18f in the Y-axis direction. The axial direction of the adjustment screw 18h coincides with the Z-axis direction. The second fixing screw 18i is a member for immovably fixing the first wedge component 18e and the second wedge component 18f after the position of the second position detector 14 in the Y-axis direction is determined. The axial direction of the second fixing screw 18i is oblique to the Y-axis direction.

Next, an effect of the linear conveyance system 1A according to the present embodiment will be described.

When the adjustment screw 18h inserted in the insertion hole 18k the magnet attachment portion 13a and the screw hole 18r of the first wedge component 18e is loosened, the first wedge component 18e moves in the positive Z-axis direction, that is, in a direction towards the base 5, while the first inclined surface 18q slides on the second inclined surface 18v. Along with the movement of the first wedge component 18e in the direction towards the base 5, the first wedge component 18e gradually moves from a thin portion to a thick portion of the second wedge component 18f, and the second wedge component 18f moves in the positive Y-axis direction, that is, in a direction in which the first gap 11 is narrowed by the movement. Consequently, the second position detector 14 installed on the second wedge component 18f moves in the direction in which the first gap 11 is narrowed by the movement.

On the other hand, when the adjustment screw 18h inserted in the insertion hole 18k of the magnet attachment portion 13a and the screw hole 18r of the first wedge component 18e is tightened, the first wedge component 18e moves in the negative Z-axis direction, that is, in a direction away from the base 5, while the first inclined surface 18q slides on the second inclined surface 18v. Along with the movement of the first wedge component 18e in the direction away from the base 5, the first wedge component 18e gradually moves from the thick portion to the thin portion of the second wedge component 18f, and the second wedge component 18f moves in the negative Y-axis direction, that is, in a direction in which the first gap 11 is widened by the movement. Consequently, the second position detector 14 installed on the second wedge component 18f moves in the direction in which the first gap 11 is widened by the movement.

Then, after the gap adjustment component 19 (not illustrated) is pressed against the first position detector 7 by the second position detector 14 to thereby determine the position of the second position detector 14 in the Y-axis direction, the second fixing screw 18i is screwed into the screw hole 18w of the second wedge component 18f and the screw hole 18s of the first wedge component 18e. Consequently, the first wedge component 18e and the second wedge component 18f are immovably fixed, and the second position detector 14 is fixed to the mover 3.

In the present embodiment, the first adjuster 18 includes the first wedge component 18e that moves in the Z-axis direction by turning the adjustment screw 18h and the second wedge component 18f that moves in the Y-axis direction along with the movement of the first wedge component 18e. With this configuration, the position of the second position detector 14 installed on the second wedge component 18f in the Y-axis direction, that is, the position of the second position detector 14 in the detector gap direction G1 can be easily adjusted, so that the gap adjustment component 19 can be easily pressed against the first position detector 7 by the second position detector 14. Note that the first adjuster 18 is not limited to that in the illustrated example, and may have any structure as long as the position of the second position detector 14 in the detector gap direction G1 can be adjusted by combining a plurality of components including inclined surfaces oblique to the detector gap direction G1 and offsetting the plurality of components. In the present embodiment, the second position detector 14 and the second wedge component 18f are formed separately, but the second position detector 14 and the second wedge component 18f may be formed integrally.

### Third Embodiment

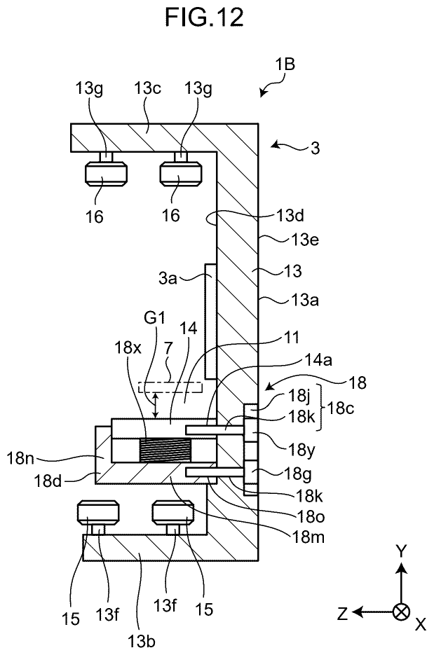

Next, a linear conveyance system 1B according to a third embodiment will be described with reference to FIG. 12. FIG. 12 is a cross-sectional view illustrating the mover 3, the first position detector 7, and the second position detector 14 of the linear conveyance system 1B according to the third embodiment. In the present embodiment, the configuration of the first adjuster 18 is different from that in the first embodiment described above. In the third embodiment, the same reference numerals are given to parts same as those in the first and second embodiments described above, and descriptions thereof will be omitted. In FIG. 12, the first position detector 7 is illustrated by a dash-dotted line, and cross-hatching of some members is omitted.

The first adjuster 18 is constituted with the through hole 18c, the housing member 18d, a biasing member 18x, the first fixing screw 18g, and a second fixing screw 18y. The configurations of the through hole 18c, the housing member 18d, and the first fixing screw 18g are the same as those in the second embodiment described above.

The first adjuster 18 moves the second position detector 14 in a direction in which the first gap 11 is narrowed by the movement and moves the second position detector 14 in a direction in which the first gap 11 is widened by the movement.

The biasing member 18x and the second position detector 14 are housed in the housing member 18d. The biasing member 18x and the second position detector 14 are stacked on the bottom wall portion 18m of the housing member 18d. The biasing member 18x and the second position detector 14 are disposed in this order, which is ascending order of distance from the bottom wall portion 18m of the housing member 18d. The biasing member 18x and the second position detector 14 are disposed between the magnet attachment portion 13a and the side wall portion 18n.

The biasing member 18x is a member that is provided between the bottom wall portion 18m and the second position detector 14 and biases the second position detector 14 in a direction in which the first gap 11 is narrowed by the biasing. The biasing member 18x is extensible and retractable in the Y-axis direction which is the detector gap direction G1. The biasing member 18x may be rubber or the like, but is a spring in the present embodiment. The spring is, for example, a coil spring or a leaf spring.

The second position detector 14 is formed with the screw hole 14a communicable with the insertion hole 18k. The second fixing screw 18y is inserted in the screw hole 14a.

The second fixing screw 18y is a member for fixing the position of the second position detector 14 in the Y-axis direction after the position of the second position detector 14 in the Y-axis direction is determined. The second fixing screw 18y is detachably attachable to the mover 3 and the second position detector 14. The position of the second fixing screw 18y can be changed to a fixing position where the second position detector 14 is immovably fixed to the mover 3 against a biasing force of the biasing member 18x and a release position where the second position detector 14 is allowed to move by the biasing force of the biasing member 18x. When the position of the second fixing screw 18y is at the fixing position, the second fixing screw 18y is inserted in the insertion hole 18k of the mover 3 and the screw hole 14a of the second position detector 14, and thereby the second position detector 14 is immovably fixed to the mover 3. When the position of the second fixing screw 18y is at the release position, the second fixing screw 18y is pulled out from at least the screw hole 14a of the second position detector 14, and thereby the second position detector 14 is allowed to move. The axial direction of the second fixing screw 18y coincides with the Z-axis direction.

Next, an effect of the linear conveyance system 1B according to the present embodiment will be described.

When the second fixing screw 18y inserted in the insertion hole 18k of the mover 3 and the screw hole 14a of the second position detector 14 is loosened, and the second fixing screw 18y is pulled out from at least the screw hole 14a of the second position detector 14, the second position detector 14 moves by the biasing force of the biasing member 18x to a positive side in the Y-axis direction, that is, in the direction in which first gap 11 is narrowed by the movement.

Then, after the gap adjustment component 19 (not illustrated) is pressed against the first position detector 7 by the second position detector 14 to thereby determine the position of the second position detector 14 in the Y-axis direction, the second fixing screw 18y is inserted into the insertion hole 18k of the mover 3 and the screw hole 14a of the second position detector 14. Consequently, the second position detector 14 is immovably fixed to the mover 3. In FIG. 12, the length of the insertion hole 18k in the Y-axis direction is the same as the diameter of the second fixing screw 18y, but the length of the insertion hole 18k in the Y-axis direction is actually larger than the diameter of the second fixing screw 18y. In this way, after the position of the second position detector 14 in the Y-axis direction, that is, the position of the second position detector 14 in the detector gap direction G1 is adjusted by the extension and retraction of the biasing member 18x, the second fixing screw 18y is reliably inserted into the insertion hole 18k of the mover 3 and the screw hole 14a of the second position detector 14, and thus the second position detector 14 can be immovably fixed to the mover 3.

In the present embodiment, the first adjuster 18 includes the biasing member 18x that biases the second position detector 14 in the direction in which the first gap 11 is narrowed by the biasing, and the second fixing screw 18y that is detachably attachable to the mover 3 and the second position detector 14. The position of the second fixing screw 18y can be changed to a fixing position where the second position detector 14 is immovably fixed to the mover 3 against a biasing force of the biasing member 18x and a release position where the second position detector 14 is allowed to move by the biasing force of the biasing member 18x. With these configurations, the position of the second position detector 14 in the Y-axis direction, that is, the position of the second position detector 14 in the detector gap direction G1 can be easily adjusted, so that the gap adjustment component 19 (not illustrated) can be easily pressed against the first position detector 7 by the second position detector 14.

### Fourth Embodiment

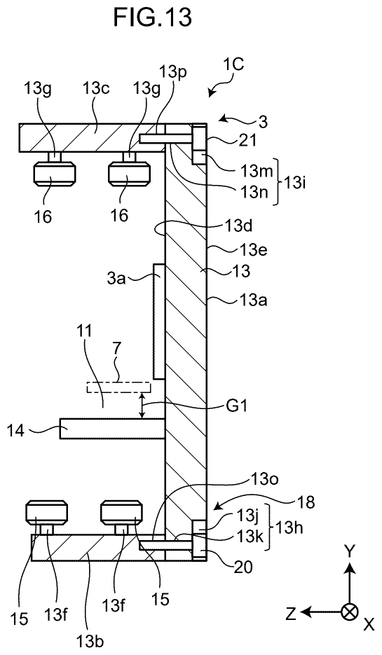

Next, a linear conveyance system 1C according to a fourth embodiment will be described with reference to FIG. 13. FIG. 13 is a cross-sectional view illustrating the mover 3, the first position detector 7, and the second position detector 14 of the linear conveyance system 1C according to the fourth embodiment. The present embodiment is different from the first embodiment described above in that the magnet attachment portion 13a and the guide roller attachment portions 13b and 13c are formed separately. In the fourth embodiment, the same reference numerals are given to parts same as those in the first embodiment described above, and descriptions thereof will be omitted. In FIG. 13, the first position detector 7 is illustrated by a dash-dotted line, and cross-hatching of some members is omitted.

The magnet attachment portion 13a, the guide roller attachment portion 13b, and the guide roller attachment portion 13c are formed separately. The second position detector 14 is provided on the first mover-side side surface 13d of the magnet attachment portion 13a. Two through holes 13h and 13i are formed in the magnet attachment portion 13a. The two through holes 13h and 13i are disposed with a space therebetween in the Y-axis direction.

The through hole 13h includes an elongated hole 13j that is open to the second mover-side side surface 13e of the magnet attachment portion 13a and has a length in the Y-axis direction longer than a length in the X-axis direction, and an insertion hole 13k that pierces from a bottom surface of the elongated hole 13j to the first mover-side side surface 13d of the magnet attachment portion 13a. A head of a fixing screw 20 is disposed in the elongated hole 13j. The fixing screw 20 is inserted in the insertion hole 13k.

The through hole 13i includes an elongated hole 13m that is open to the second mover-side side surface 13e of the magnet attachment portion 13a and has a length in the Y-axis direction longer than a length in the X-axis direction, and an insertion hole 13n that pierces from a bottom surface of the elongated hole 13m to the first mover-side side surface 13d of the magnet attachment portion 13a. A head of a fixing screw 21 is disposed in the elongated hole 13m. The fixing screw 21 is inserted in the insertion hole 13n.

The guide roller attachment portion 13b as one of the guide roller attachment portions is formed with a screw hole 130 communicable with the insertion hole 13k. The fixing screw 20 is inserted in the screw hole 130. The guide roller attachment portion 13c as the other of the guide roller attachment portions is formed with a screw hole 13p communicable with the insertion hole 13n. The fixing screw 21 is inserted in the screw hole 13p. In the mover 3 of the present embodiment, the first adjuster 18 is constituted with the magnet attachment portion 13a, the guide roller attachment portions 13b and 13c, the through holes 13h and 13i, the screw holes 130 and 13p, and the fixing screws 20 and 21. The first adjuster 18 moves the second position detector 14 in a direction in which the first gap 11 is narrowed by the movement and moves the second position detector 14 in a direction in which the first gap 11 is widened by the movement.

Next, an effect of the linear conveyance system 1C according to the present embodiment will be described.

The fixing screw 20 inserted in the insertion hole 13k of the magnet attachment portion 13a and the screw hole 130 of the guide roller attachment portion 13b is loosened to pull out the fixing screw 20 at least from the screw hole 130 of the guide roller attachment portion 13b, and the fixing screw 21 inserted in the insertion hole 13n of the magnet attachment portion 13a and the screw hole 13p of the guide roller attachment portion 13c is loosened to pull out the fixing screw 21 at least from the screw hole 13p of the guide roller attachment portion 13c. It is not always necessarily to pull out the fixing screws 20 and 21 from the screw holes 130 and 13p, and it is sufficient that the magnet attachment portion 13a can be moved with respect to the guide roller attachment portion 13b and the guide roller attachment portion 13c by loosening the fixing screws 20 and 21. In this way, by changing the position of the magnet attachment portion 13a in the Y-axis direction with respect to the guide roller attachment portions 13b and 13c, the second position detector 14 provided on the magnet attachment portion 13a can be moved in the direction in which the first gap 11 is narrowed by the movement or the direction in which the first gap 11 is widened by the movement.

Then, after the gap adjustment component 19 (not illustrated) is pressed against the first position detector 7 by the second position detector 14 to thereby determine the position of the second position detector 14 in the Y-axis direction, the fixing screw 20 is inserted into the insertion hole 13k of the magnet attachment portion 13a and the screw hole 130 of the guide roller attachment portion 13b, and the fixing screw 21 is inserted into the insertion hole 13n of the magnet attachment portion 13a and the screw hole 13p of the guide roller attachment portion 13c.

Consequently, the position of the second position detector 14 in the Y-axis direction can be fixed. In FIG. 13, the length of the insertion hole 13k in the Y-axis direction is the same as the diameter of the fixing screw 20, but the length of the insertion hole 13k in the Y-axis direction is actually larger than the diameter of the fixing screw 20. In addition, in FIG. 13, the length of the insertion hole 13n in the Y-axis direction is the same as the diameter of the fixing screw 21, but the length of the insertion hole 13n in the Y-axis direction is actually larger than the diameter of the fixing screw 21. In this way, after adjusting the position of the second position detector 14 in the Y-axis direction, the fixing screw 20 is reliably inserted into the insertion hole 13k and the screw hole 130, the fixing screw 21 is reliably inserted into the insertion hole 13n and the screw hole 13p, and thus the position of the second position detector 14 in the Y-axis direction can be fixed.

In the present embodiment, the first adjuster 18 includes the fixing screw 20 detachably attachable to the magnet attachment portion 13a and the guide roller attachment portion 13b, and the fixing screw 21 detachably attachable to the magnet attachment portion 13a and the guide roller attachment portion 13c. The position of the fixing screw 20 can be changed to a fixing position where the magnet attachment portion 13a is immovably fixed to the guide roller attachment portion 13b and a release position where the magnet attachment portion 13a is allowed to move with respect to the guide roller attachment portion 13b.

The position of the fixing screw 21 can be changed to a fixing position where the magnet attachment portion 13a is immovably fixed to the guide roller attachment portion 13c and a release position where the magnet attachment portion 13a is allowed to move with respect to the guide roller attachment portion 13c. With these configurations, along with the movement of the magnet attachment portion 13a with respect to the guide roller attachment portion 13c, the position of the second position detector 14 in the Y-axis direction, that is, the position of the second position detector 14 in the detector gap direction G1 can be easily adjusted, so that the gap adjustment component 19 can be easily pressed against the first position detector 7 by the second position detector 14. In the present embodiment, the second position detector 14 is attached to the magnet attachment portion 13a, but may be attached to a component other than the magnet attachment portion 13a. That is, an object to which the second position detector 14 is attached may be any component that moves so that the position of the second position detector 14 in the detector gap direction G1 can be adjusted.

### Fifth Embodiment

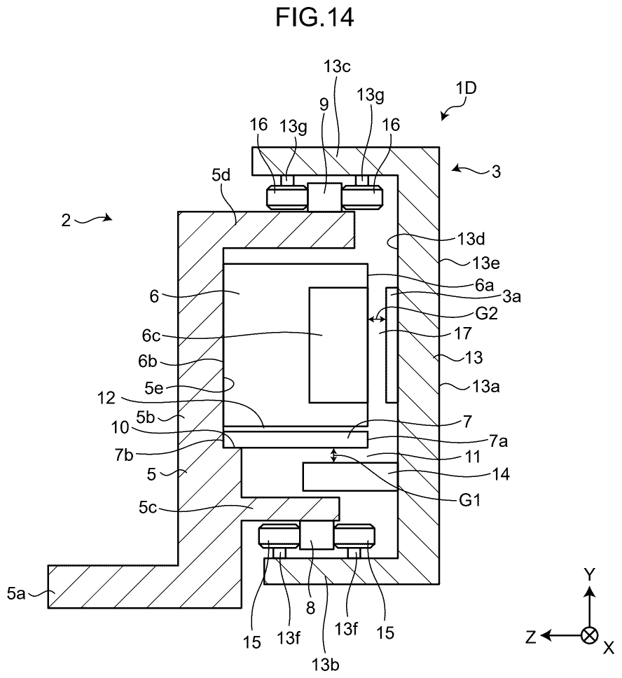

Next, a linear conveyance system 1D according to a fifth embodiment will be described with reference to FIG. 14. FIG. 14 is a cross-sectional view illustrating the linear conveyance system 1D according to the fifth embodiment. The present embodiment is different from the first embodiment described above in that the first position detector 7 is brought into direct contact with the first positioning portion 10. In the fifth embodiment, the same reference numerals are given to parts same as those in the first embodiment described above, and descriptions thereof will be omitted.

The first position detector 7 is directly attached to the base 5. The first position detector 7 is disposed below the stator 6 away from the stator 6. The first position detector 7 includes a first side surface 7a facing the mover 3 and a second side surface 7b facing opposite the mover 3. The second side surface 7b is in contact with the base-side side surface 5e. A part of a surface of the first position detector 7 facing the second position detector 14 is in contact with the first positioning portion 10. Hereinafter, in the present embodiment, the surface of the first position detector 7 facing the second position detector 14 may be referred to as a lower surface. In the present embodiment, a surface of the first position detector 7 opposite to the lower surface may be referred to as an upper surface. A portion of the lower surface of the first position detector 7, the portion being in the vicinity of a boundary with the second side surface 7b, is in contact with the first positioning portion 10. In a state where the first position detector 7 is in contact with the first positioning portion 10, on an opposite side of the first position detector 7 from the second position detector 14, the space 12 for allowing movement of the first position detector 7 in the direction in which the first gap 11 is widened by the movement is provided. The space 12 is formed between the upper surface of the first position detector 7 and the lower surface of the stator 6.

Next, a method for manufacturing the linear conveyance system 1D according to the present embodiment will be described. The method for manufacturing the linear conveyance system 1D includes a first positioning step, a temporary fixing step, a second positioning step, a first fixing step, a moving step, a take-out step, a third positioning step, and a second fixing step.

The first positioning step is a step of positioning the first position detector 7 in the detector gap direction G1 by bringing the first position detector 7 into contact with the first positioning portion 10 to restrict the movement of the first position detector 7 in the direction in which the first gap 11 is narrowed by the movement. In the first positioning step, a part of the lower surface of the first position detector 7 is brought into contact with a step which is the first positioning portion 10. In the first positioning step, the position of the first position detector 7 in the detector gap direction G1 is determined.

The temporary fixing step is a step of fixing the first position detector 7 to the base 5. In the temporary fixing step, the first position detector 7 is fixed to the base 5 by a fixing screw (not illustrated). The temporary fixing step may be skipped, but by fixing the first position detector 7 to the base 5 in the temporary fixing step, it is possible to eliminate, in respective steps of manufacturing the linear conveyance system 1D including the second positioning step to be described later, the possibility of displacement of the first position detector 7 from the position determined in the first positioning step, and the respective steps can be smoothly advanced.

The second positioning step is the same as the second positioning step of the first embodiment described above. The first fixing step is the same as the first fixing step of the first embodiment described above.

The moving step is a step of moving the first position detector 7 in the direction in which the first gap 11 is widened by the movement. In the moving step, a fixing screw (not illustrated) is loosened to make the first position detector 7 movable with respect to the base 5, and then the first position detector 7 is moved in the direction in which the first gap 11 is widened by the movement. Consequently, the width of the first gap 11 becomes larger than the thickness of the gap adjustment component 19 (not illustrated), and thus the gap adjustment component 19 can be easily taken out from the first gap 11.

The take-out step is a step of taking out the gap adjustment component 19 from the first gap 11. In the take-out step, the gap adjustment component 19 is moved in the X-axis direction which is a direction perpendicular to the detector gap direction G1, and is taken out from the first gap 11.

The third positioning step is a step of positioning the first position detector 7 in the detector gap direction G1 by bringing the first position detector 7 into contact with the first positioning portion 10 to restrict the movement of the first position detector 7 in the direction in which the first gap 11 is narrowed by the movement. In the third positioning step, a part of the lower surface of the first position detector 7 is brought into contact with the step which is the first positioning portion 10. In the third positioning step, the position of the first position detector 7 in the detector gap direction G1 is determined.

The second fixing step is a step of fixing the first position detector 7 to the base 5. In the second fixing step, the first position detector 7 is fixed to the base 5 by a fixing screw (not illustrated). Subsequently, in the second fixing step, the stator 6 is fixed to the base 5 by a fixing screw (not illustrated). By performing the above steps, the linear conveyance system 1D illustrated in FIG. 14 can be assembled and manufactured.

In order to move the first position detector 7 in the direction in which the first gap 11 is widened by the movement, it is preferable that the stator 6 be not disposed between the base 5 and the mover 3 until the second fixing step is performed. However, if the space 12 is provided between the first position detector 7 and the stator 6 as illustrated in FIG. 14, and thus the first position detector 7 can be moved in the direction in which the first gap 11 is widened by the movement, the timing of fixing the stator 6 to the base 5 is not particularly limited.

Next, an effect of the linear conveyance system 1D according to the present embodiment will be described.

In the present embodiment, since the first position detector 7 is provided on the base 5 and is in direct contact with the first positioning portion 10, the first position detector 7 can be positioned accurately with respect to the first positioning portion 10, without being affected by tolerances of a plurality of stators 6.

### Sixth Embodiment

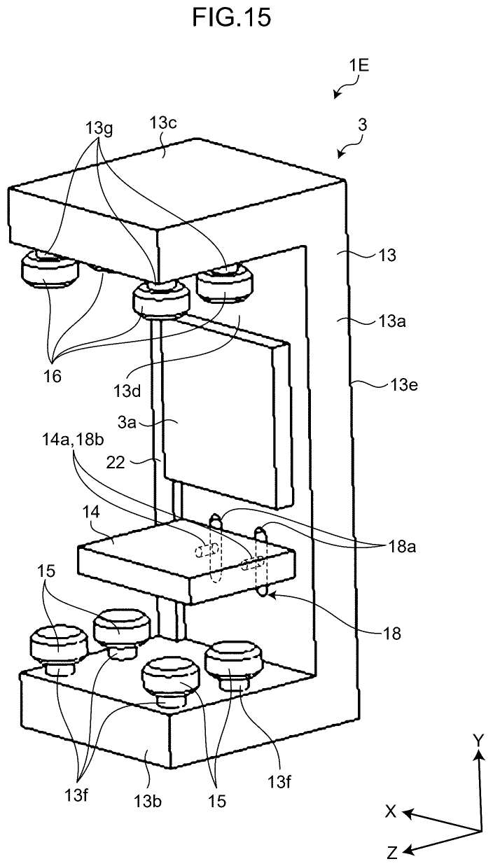

Next, a linear conveyance system 1E according to a sixth embodiment will be described with reference to FIG. 15. FIG. 15 is a perspective view illustrating the mover 3 of the linear conveyance system 1E according to the sixth embodiment. The present embodiment is different from the first embodiment described above in that a conveyance direction positioning portion 22 is provided on the mover 3. In the sixth embodiment, the same reference numerals are given to parts same as those in the first embodiment described above, and descriptions thereof will be omitted.

The mover 3 is provided with the conveyance direction positioning portion 22 configured to restrict the movement of the second position detector 14 in the conveyance direction of the mover 3. The conveyance direction positioning portion 22 is provided on the first mover-side side surface 13d of the magnet attachment portion 13a. In the present embodiment, the conveyance direction positioning portion 22 is a protrusion that protrudes in the Z-axis direction from the first mover-side side surface 13d of the magnet attachment portion 13a toward the stator 6 (not illustrated). The conveyance direction positioning portion 22 extends in the Y-axis direction. The conveyance direction positioning portion 22 is located on a front side in the conveyance direction with respect to the second position detector 14 and the motor magnet 3a. The conveyance direction positioning portion 22 is in contact with a side surface of the second position detector 14, the side surface being on the front side in the conveyance direction, and a side surface of the motor magnet 3a, the side surface being on the front side in the conveyance direction.

Next, an effect of the linear conveyance system 1E according to the present embodiment will be described.

In the present embodiment, since the mover 3 is provided with the conveyance direction positioning portion 22 that restricts the movement of the second position detector 14 in the conveyance direction of the mover 3, the position of the second position detector 14 in the conveyance direction can be determined. Consequently, when replacement of the second position detector 14, readjustment of the position of the second position detector 14, or the like is made, it is possible to prevent positional displacement of the second position detector 14 in the conveyance direction.

The conveyance direction positioning portion 22 is not particularly limited as long as the structure thereof is capable of restricting the movement of the second position detector 14 in the conveyance direction of the mover 3. The conveyance direction positioning portion 22 may be, for example, a pin attached to the mover 3 and protruding from the mover 3 toward the stator 6. The pin is formed separately from the mover 3. The pin protrudes toward the stator 6 beyond the first mover-side side surface 13d. In a case where the first positioning portion 10 is the pin, it is preferable that at least two pins be disposed side by side in the Y-axis direction. For example, the conveyance direction positioning portion 22 may be constituted with a protrusion or a pin protruding from the second position detector 14 toward the mover 3, and a hole provided in the mover 3 and into which the protrusion or the pin of the second position detector 14 is fitted. The shape of the protrusion is not particularly limited. The shape of the protrusion may be, for example, a columnar shape, or a quadrangular prism shape longer in the Y-axis direction than in the X-axis direction. The shape of the hole is appropriately changed depending on the shape of the protrusion or the pin. In the present embodiment, the conveyance direction positioning portion 22 is in direct contact with the second position detector 14, but may be in indirect contact with the second position detector 14 via another component.

### Seventh Embodiment

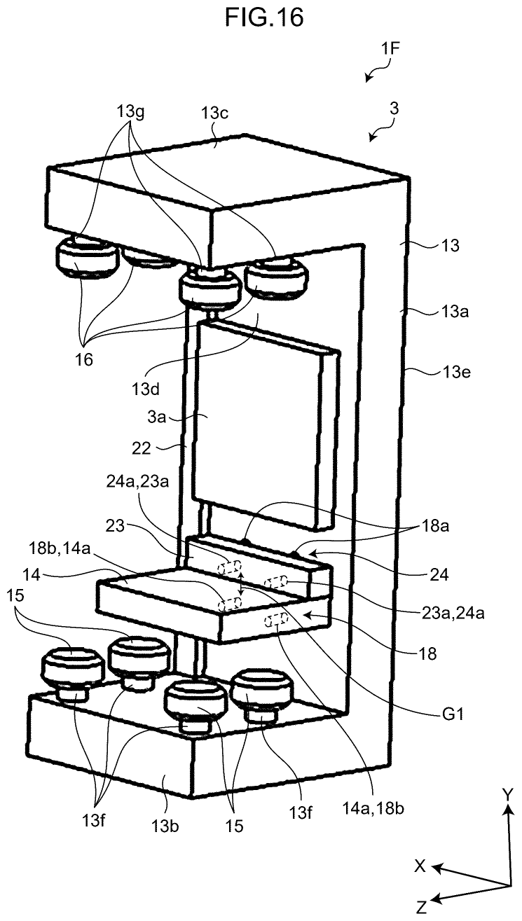

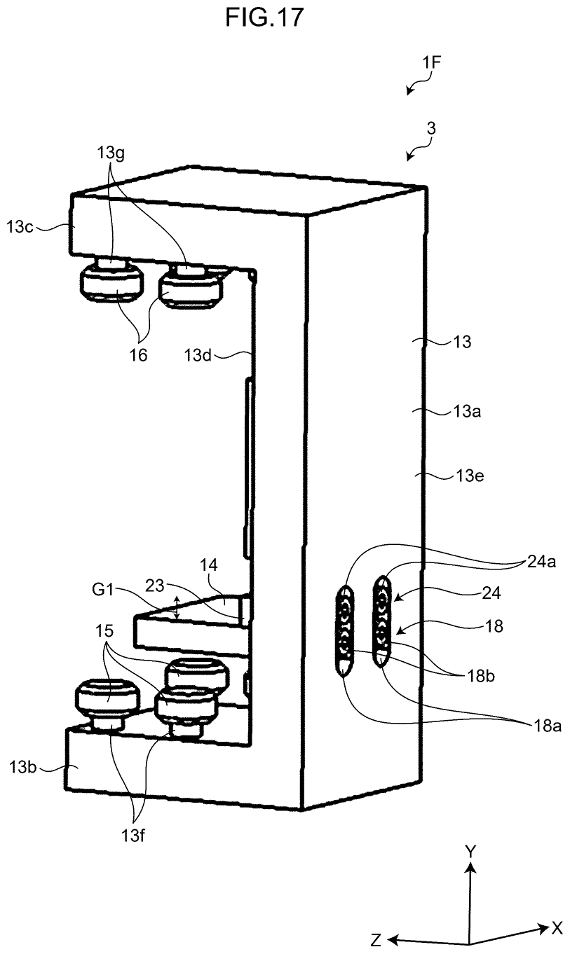

Next, a linear conveyance system 1F according to a seventh embodiment will be described with reference to FIGS. 16 and 17. FIG. 16 is a perspective view illustrating the mover 3 of the linear conveyance system 1F according to the seventh embodiment. FIG. 17 is a perspective view illustrating the mover 3 of the linear conveyance system 1F according to the seventh embodiment, as viewed from an opposite side to that in FIG. 16. The present embodiment is different from the first embodiment described above in that a second positioning portion 23 and a second adjuster 24 are provided on the mover 3. In the seventh embodiment, the same reference numerals are given to parts same as those in the first embodiment described above, and descriptions thereof will be omitted.

The mover 3 is provided with the second positioning portion 23. The second positioning portion 23 is provided on the first mover-side side surface 13d of the magnet attachment portion 13a. The second positioning portion 23 is a portion that restricts the movement of the second position detector 14 in the direction in which the first gap 11 (not illustrated) is narrowed by the movement and allows the movement of the second position detector 14 in the direction in which the first gap 11 is widened by the movement. The second positioning portion 23 is formed separately from the mover 3. In the present embodiment, the second positioning portion 23 is attached to the first mover-side side surface 13d of the mover 3, and protrudes from the first mover-side side surface 13d toward the stator 6 (not illustrated).

The second positioning portion 23 extends in the X-axis direction. The shape of the second positioning portion 23 is a quadrangular prism longer in the X-axis direction than in the Y-axis direction in the present embodiment, but may be appropriately changed. The second positioning portion 23 is disposed above the second position detector 14. A lower surface of the second positioning portion 23 is in contact with a part of an upper surface of the second position detector 14. The position of the second positioning portion 23 as viewed along the Y-axis direction is at a position that does not overlap the first position detector 7 so as not to hinder the detection of the position of the mover 3 by the first position detector 7 (not illustrated) and the second position detector 14.

The mover 3 is provided with the second adjuster 24 capable of adjusting the position of the second positioning portion 23 in the Y-axis direction, that is, the position of the second positioning portion 23 in the detector gap direction G1. In the mover 3 of the present embodiment, the second adjuster 24 is constituted with the elongated holes 18a and fixing screws 24a. As illustrated in FIG. 16, the second positioning portion 23 is formed with screw holes 23a each communicating with the elongated hole 18a. Each fixing screw 24a is inserted in the elongated hole 18a and the screw hole 23a. By screwing each fixing screw 24a inserted in the elongated hole 18a into the screw hole 23a, the second positioning portion 23 is fixed to the mover 3. As illustrated in FIG. 17, the elongated holes 18a are also used as the first adjuster 18. A length dimension of the elongated hole 18a in the Y-axis direction is larger than the diameter of the fixing screw 24a. With this configuration, the fixing screw 24a inserted in the elongated hole 18a can be moved in the Y-axis direction. In a case of adjusting the position of the second positioning portion 23 in the Y-axis direction, it is only required to change the positions of the fixing screws 24a inserted in the elongated holes 18a in the Y-axis direction, and to screw the fixing screws 24a into the screw holes 23a.

Next, an effect of the linear conveyance system 1F according to the present embodiment will be described.

In the present embodiment, the mover 3 is provided with the second positioning portion 23 configured to: restrict the movement of the second position detector 14 in the direction in which the first gap 11 is narrowed by the movement; and allow the movement of the second position detector 14 in the direction in which the first gap 11 is widened by the movement. In addition, in the present embodiment, the mover 3 is provided with the second adjuster 24 capable of adjusting the position of the second positioning portion 23 in the detector gap direction G1. With these configurations, after the position of the second position detector 14 in the detector gap direction G1 is determined and the second position detector 14 is fixed to the mover 3, the second positioning portion 23 can be disposed at a position where the movement of the second position detector 14 in the direction in which the first gap 11 is narrowed by the movement is restricted.

Consequently, when the second position detector 14 is replaced, the position of a new second position detector 14 in the detector gap direction G1 can be determined by the second positioning portion 23, so that the necessity of work of adjusting the first gap 11 when replacing the second position detector 14 is eliminated.

The second positioning portion 23 is not particularly limited as long as the structure thereof is capable of restricting the movement of the second position detector 14 in the direction in which the first gap 11 is narrowed by the movement and allowing the movement of the second position detector 14 in the direction in which the first gap 11 is widened by the movement. The second positioning portion 23 may be, for example, a pin attached to the mover 3 and protruding from the mover 3 toward the stator 6. The pin is formed separately from the mover 3.

The pin protrudes toward the stator 6 beyond the first mover-side side surface 13d. In a case where the second positioning portion 23 is the pin, it is preferable that at least two pins be disposed side by side in the X-axis direction. For example, the second positioning portion 23 may be constituted with a protrusion or a pin protruding from the second positioning portion 23 toward the mover 3, and a hole provided in the mover 3 and into which the protrusion or the pin of the second positioning portion 23 is fitted. The shape of the protrusion is not particularly limited. The shape of the protrusion may be, for example, a columnar shape, or a quadrangular prism shape longer in the X-axis direction than in the Y-axis direction. The shape of the hole is appropriately changed depending on the shape of the protrusion or the pin. In the present embodiment, the second positioning portion 23 is in direct contact with the second position detector 14, but may be in indirect contact with the second position detector 14 via another component.

### Eighth Embodiment

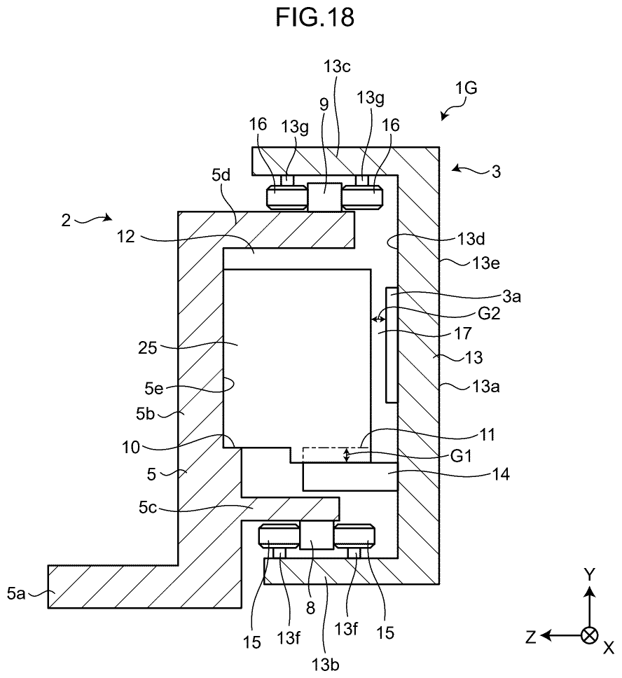

Next, a linear conveyance system 1G according to an eighth embodiment will be described with reference to FIG. 18. FIG. 18 is a cross-sectional view for explaining a method for manufacturing the linear conveyance system 1G according to the eighth embodiment. The present embodiment is different from the first embodiment described above in that the second position detector 14 is positioned by using a jig 25. In the eighth embodiment, the same reference numerals are given to parts same as those in the first embodiment described above, and descriptions thereof will be omitted.

The method for manufacturing the linear conveyance system 1G according to the present embodiment includes a first positioning step, a temporary fixing step, a second positioning step, a first fixing step, a moving step, a take-out step, a third positioning step, and a second fixing step.

The first positioning step is a step of positioning the jig 25 in the detector gap direction G1 by bringing the jig 25 corresponding to the shapes of the stator 6, the first position detector 7, and the first gap 11 into contact with the first positioning portion 10 to restrict the movement of the jig 25 in a direction in which the first gap 11 is narrowed by the movement. In FIG. 18, the first gap 11 is illustrated by a dash-dotted line. In the first positioning step, a part of a lower surface of the jig 25 is brought into contact with a step which is the first positioning portion 10. In the first positioning step, the position of the jig 25 in the detector gap direction G1 is determined. The space 12 for allowing movement of the jig 25 in a direction in which the first gap 11 is widened by the movement is provided on an opposite side of the jig 25 from the second position detector 14. The space 12 is formed between an upper surface of the jig 25 and the lower surface of the guide rail attachment portion 5d.

The temporary fixing step is a step of fixing the jig 25 to the base 5. In the temporary fixing step, the jig 25 is fixed to the base 5 by a fixing screw (not illustrated). The temporary fixing step may be skipped, but by fixing the jig 25 to the base 5 in the temporary fixing step, it is possible to eliminate, in respective steps of manufacturing the linear conveyance system 1G including the second positioning step to be described later, the possibility of displacement of the jig 25 from the position determined in the first positioning step, and the respective steps can be smoothly advanced.

The second positioning step is a step of positioning the second position detector 14 in the detector gap direction G1 by bringing the second position detector 14 into contact with the jig 25. In the second positioning step, the second position detector 14 is moved toward the jig 25 to press the second position detector 14 against the jig 25, and thereby the position of the second position detector 14 in the detector gap direction G1 is determined. The second position detector 14 is pressed against a part of the lower surface of the jig 25.

The first fixing step is a step of fixing the second position detector 14 to the mover 3 in a state where the second position detector 14 is in contact with the jig 25. In the first fixing step, the second position detector 14 is fixed to the mover 3 in the same method as in the first fixing step of the first embodiment.

The moving step is a step of moving the jig 25 in the direction in which the first gap 11 is widened by the movement. In the moving step, a fixing screw (not illustrated) is loosened to make the jig 25 movable with respect to the base 5, and then the jig 25 is moved in the direction in which the first gap 11 is widened by the movement. Consequently, the jig 25 is separated from the second position detector 14, and thus the jig 25 can be easily taken out from between the base 5 and the mover 3.

The take-out step is a step of taking out the jig 25 from between the base 5 and the mover 3. In the take-out step, the jig 25 is moved in the X-axis direction which is a direction perpendicular to the detector gap direction G1, and is taken out from between the base 5 and the mover 3.

The third positioning step is the same as the third positioning step of the first embodiment described above. The second fixing step is the same as the second fixing step of the first embodiment described above. By performing the above steps, the linear conveyance system 1G can be assembled and manufactured. In a case where the first position detector 7 is brought into direct contact with the first positioning portion 10 as in the fifth embodiment described above, the third positioning step is the same as the third positioning step of the fifth embodiment described above, and the second fixing step is the same as the second fixing step of the fifth embodiment described above.

Next, an effect of the linear conveyance system 1G according to the present embodiment will be described.

In the present embodiment, by positioning the second position detector 14 by using the jig 25, the second position detector 14 can be positioned accurately without being affected by the tolerances of the plurality of stators 6.

The configurations described in the above embodiments are merely examples and can be combined with other known technology, the embodiments can be combined with each other, and part of the configurations can be omitted or modified without departing from the gist thereof.

### REFERENCE SIGNS LIST

1, 1A, 1B, 1C, 1D, 1E, 1F, 1G linear conveyance system; 2 track module; 3 mover; 3a motor magnet; 4 conveyance line; 5 base; 5a bottom portion; 5b holding portion; 5c, 5d guide rail attachment portion; 5e base-side side surface; 6 stator; 6a first stator-side side surface; 6b second stator-side side surface; 6c coil; 7 first position detector; 7a first side surface; 7b second side surface; 8, 9 guide rail; 10 first positioning portion; 10a protrusion; 10b hole; 11 first gap; 12 space; 13 mover main body; 13a magnet attachment portion; 13b, 13c guide roller attachment portion; 13d first mover-side side surface; 13e second mover-side side surface; 13f, 13g guide roller shaft; 13h, 13i, 18c through hole; 13j, 13m, 18a, 18j elongated hole; 13k, 13n, 18k insertion hole; 130, 13p, 14a, 180, 18r, 18s, 18w, 23a screw hole; 14 second position detector; 15, 16 guide roller; 17 second gap; 18 first adjuster; 18b, 20, 21, 24a fixing screw; 18d housing member; 18e first wedge component; 18f second wedge component; 18g first fixing screw; 18h adjustment screw; 18i, 18y second fixing screw; 18m bottom wall portion; 18n side wall portion; 18p bottom surface; 18q first inclined surface; 18t placement surface; 18u attachment surface; 18v second inclined surface; 18x biasing member; 19 gap adjustment component; 22 conveyance direction positioning portion; 23 second positioning portion; 24 second adjuster; 25 jig; G1 detector gap direction; G2 coil gap direction.

1. A linear conveyance system comprising:
a base of a conveyance path module constituting a conveyance path;
a mover configured to move along the conveyance path;
a stator provided on the base and constituting a linear motor together with the mover;
a first position detector provided on any one of the base and the stator; and
a second position detector configured to detect a position of the mover together with the first position detector, the second position detector being provided on the mover, wherein
the first position detector and the second position detector are disposed with a first gap therebetween in a first direction,
the base is provided with a first positioning portion that restricts movement of the first position detector in a direction in which the first gap is narrowed by the movement and allows movement of the first position detector in a direction in which the first gap is widened by the movement, and
the mover is provided with a first adjuster capable of adjusting a position of the second position detector in the first direction.

2. The linear conveyance system according to claim 1, wherein
the stator includes a coil,
the mover includes a permanent magnet disposed with a second gap from the coil in a second direction, and
the second direction is a direction perpendicular to the first direction.

3. The linear conveyance system according to claim 1, wherein
the mover is provided with a conveyance direction positioning portion configured to restrict movement of the second position detector in a conveyance direction of the mover.

4. The linear conveyance system according to claim 1, wherein
the mover is provided with a second positioning portion configured to restrict movement of the second position detector in a direction in which the first gap is narrowed by the movement and to allow movement of the second position detector in a direction in which the first gap is widened by the movement.

5. A method for manufacturing a linear conveyance system, the linear conveyance system comprising:
a base of a conveyance path module constituting a conveyance path;
a mover configured to move along the conveyance path;
a stator provided on the base and constituting a linear motor together with the mover;
a first position detector provided on any one of the base and the stator; and
a second position detector configured to detect a position of the mover together with the first position detector, the second position detector being provided on the mover, wherein
the first position detector and the second position detector are disposed with a first gap therebetween in a first direction,
the base is provided with a first positioning portion configured to restrict movement of the first position detector in a direction in which the first gap is narrowed by the movement and to allow movement of the first position detector in a direction in which the first gap is widened by the movement, and the mover is provided with a first adjuster capable of adjusting a position of the second position detector in the first direction, the method for manufacturing the linear conveyance system comprising:
positioning the first position detector in the first direction by bringing the stator or the first position detector into contact with the first positioning portion to restrict movement of the first position detector in a direction in which the first gap is narrowed by the movement;
positioning the second position detector in the first direction by sandwiching a gap adjustment component between the first position detector and the second position detector;
fixing the second position detector to the mover in a state where the gap adjustment component is sandwiched between the first position detector and the second position detector;
moving the first position detector in a direction in which the first gap is widened by the movement; and
taking out the gap adjustment component from the first gap.

6. A method for manufacturing a linear conveyance system, the linear conveyance system comprising:
a base of a conveyance path module constituting a conveyance path;
a mover configured to move along the conveyance path;
a stator provided on the base and constituting a linear motor together with the mover;
a first position detector provided on any one of the base and the stator; and
a second position detector configured to detect a position of the mover together with the first position detector, the second position detector being provided on the mover, wherein
the first position detector and the second position detector are disposed with a first gap therebetween in a first direction,
the base is provided with a first positioning portion configured to restrict movement of the first position detector in a direction in which the first gap is narrowed by the movement and to allow movement of the first position detector in a direction in which the first gap is widened by the movement, and the mover is provided with a first adjuster capable of adjusting a position of the second position detector in the first direction, the method for manufacturing the linear conveyance system comprising:
positioning a jig in the first direction by bringing the jig that is a jig corresponding to shapes of the stator, the first position detector, and the first gap into contact with the first positioning portion to restrict movement of the jig in a direction in which the first gap is narrowed by the movement;
fixing the second position detector to the mover in a state where the second position detector is in contact with the jig;
moving the jig in a direction in which the first gap is widened by the movement; and
taking out the jig from between the base and the mover.
